(19) United States
(12) Patent Application Publication
(10) Pub. No.: US 2004/0054677 A1
(43) Pub. Date: Mar. 18, 2004

(54) Method for processing text in a computer and a computer

(76) Inventors: Hans-Georg Mueller, Weissach (DE); Alexander Kopcsa, Moedling (AT); Edgar Schiebel, Pfaffstetten (AT); Clemens Widhalm, Wien (AT)

Correspondence Address: KENYON & KENYON, ONE BROADWAY, NEW YORK, NY, 10004, US

(21) Appl. No.: 10/416,966

(22) PCT Filed: Nov. 16, 2001
(86) PCT No.: PCT/DE01/04308

(30) Foreign Application Priority Data
Nov. 21, 2000 (DE) 100 57 634.6

(51) Int. Cl. G06F 7/00

(52) U.S. Cl. 707/100

(57) ABSTRACT

A method for processing text in a computer unit (1) and a computer unit (1) are proposed which enable key word lists to be efficiently generated. In the process, a first list (5) of key words is generated, a first text (10) being partitioned into a plurality of text chunks which are separated from one another by predefined text components of a text component list (20) stored in a memory (15) assigned to the computer unit (1). At least one portion of a text chunk is entered into the first list (5) of key words when its frequency of occurrence in the first text (10) exceeds a first predefined value. In a first step, all word groups in the remaining text chunks are sought which include a first predefined number of directly adjacent words. Of these word groups in the text chunks, those are subsequently deleted whose frequency of occurrence in the first text exceeds the first predefined value and which, therefore, are entered into the first list (5) of key words. In a second step, all word groups in the remaining text chunks are sought which include a second predefined number of directly adjacent words, the second predefined number of words being smaller than the first predefined number of words.

### BACKGROUND INFORMATION

The present invention is directed to a method for processing text in a computer unit, and to a computer unit according to the definition of the species in the independent claims.

A method and a device for recognizing phrases in a text are already known from U.S. Pat. No. 5,819,260. In this context, a text to be scanned is partitioned into a plurality of text chunks of directly adjacent words, these text chunks being separated from one another by predefined text components in the form of words or punctuation marks from a special text component list. In addition, a list of key words is provided, into which these text chunks or parts thereof are entered when their frequency of occurrence in the text exceeds a given value.

### SUMMARY OF THE INVENTION

It contrast, the method according to the present invention for processing text in a computer unit and the computer unit according to the present invention having the features of the corresponding independent claims have the advantage that, in a first step, all of those word groups are sought in the text chunks which include a first predefined number of directly adjacent words, that, subsequently, of these word groups in the text chunks, those are deleted whose frequency of occurrence in the first text exceed the first predefined value and which are, therefore, entered into the first list of key words, and that, in a second step, all word groups in the remaining text chunks are sought which include a second predefined number of directly adjacent words, the second predefined number of words being smaller than the first predefined number of words. In this way, a maximum number of key word groups, which are characteristic of the text, may be extracted quickly and efficiently from the scanned text. By limiting the preset number of directly adjacent words to a practical value, for example five, it is possible to further reduce the outlay required for searching for key word groups in the text. Typically, word groups having more than five directly adjacent words occur seldom and, therefore, as a rule, are not suited for characterizing texts. By evaluating all word groups having a predefined number of directly adjacent words in the text, it is additionally ensured that key word groups characteristic of the text and having this number of directly adjacent words do not go undetected.

Advantageous further refinements and improvements of the method for processing text in a computer unit and of the computer unit according to the independent claims are derived from the measures delineated in the dependent claims.

It is particularly advantageous that the second predefined number of words is selected to be smaller by one than the first predefined number of words. In this way, even after deleting the word groups entered into the first list of key words, it is possible to extract a maximum of key word groups from the word groups remaining in the text using the first predefined number of directly adjacent words from the text.

A further benefit is derived in that a plurality of documents is combined with the first text, and in that a word group is only entered into the first list of key words when its frequency of occurrence exceeds a second predefined value in at least one predefined number of documents. In this manner, only those word groups are entered into the first list of key words which are also characteristic of a plurality of documents. In this manner, certain word groups which appear in one document due to an author's preference, and which do not turn up in the remaining documents and, therefore, are also not characteristic of the entire text, may be masked out, thereby preventing them from being entered into the first list of key words.

A further advantage is attained in that the first text is expanded by a second text having a second list of key words, and a shared list of key words is generated into which a word group is entered when it is contained in the first list of key words or in the second list of key words. In this manner, when adding the second text to the first text, there is no need to scan the resulting total text again for key words, but rather only the second text being newly added. This makes it possible to reduce the outlay required for ascertaining key word groups. when adding a second text to the first text. In this way, the search for key word groups is substantially accelerated for the total text resulting from the first text and the second text. Yet another benefit is derived in that the frequency of occurrence of a word group in the first list of key words is added to the frequency of occurrence of the same word group in the second list of key words, and in that the thus formed total frequency of occurrence of this word group is entered into the shared list of key words in association with this word group. In this way, it is possible to recognize trends in the use of key word groups in texts. When the total frequency of occurrence of a key word group increases when new texts are continually added to a total text, then this indicates that this key word group is gaining in significance for characterizing the total text and, therefore, is also particularly well suited as a search word group for searching out other documents of the same specific field.

A further benefit is derived in that the first text is formed from a third text and a fourth text, the frequency of occurrence of an ascertained word group in the third text is added with the frequency of occurrence of the same word group in the fourth text, in order to ascertain the frequency of occurrence of this word group in the first text. In this manner, when generating the first key word list for the first text, those word groups are also considered which, neither in the third text nor in the fourth text, reach the predefined frequency of occurrence for inclusion in a key word list assigned to the third text or the fourth text. For this, however, it is not necessary to again conduct a search operation for the appropriate word groups in the third text and in the fourth text, rather the frequencies of occurrence ascertained for the found word groups in an earlier search operation for such word groups that had been conducted separately for the third text and the fourth text may be used. Another advantage is that only those word groups which end with a noun are selected for inclusion in the first list of key words. In this way, to the greatest extent possible, only meaningful word groups are selected. It turns out that word groups that do not end with a noun have little in terms of content. Thus is true, above all, in German and English.

### BRIEF DESCRIPTION OF THE DRAWINGS

One exemplary embodiment of the present invention is illustrated in the drawing and is elucidated in the following description. FIG. 1 shows a block diagram of a computer unit according to the present invention;

FIG. 2 a flow chart of the method according to the present invention;

FIG. 3 a flow chart for selecting a key word group for a text composed of a plurality of documents; and FIG. 4, a flow chart for generating a common list of key words.

### DESCRIPTION OF THE EXEMPLARY EMBODIMENT

In FIG. 1, 1 denotes a computer unit, for example a computer. Computer unit 1 include means 35 for partitioning a first text into a subdivided text 11. They are designated in the following as partitioning means 35. Connected to partitioning means 35 is a memory 15, which, as illustrated in FIG. 1, is configured in computer unit 1. Memory 15 could, however, also be configured outside of computer unit 1 and be assigned to computer unit 1. Computer unit 1 also includes a search tool 50, which searches for word groups in partitioned text 11. Means 40 for ascertaining the frequency of occurrence of the word groups located by search tool 50 are linked to search tool 50. Selection means 45 are connected to means 40 for ascertaining the frequency of occurrence. Selection means 45 are connected to a deletion device 55 which is used for deleting word groups in partitioned text 11. Selection means 45 themselves are used for selecting a word group of partitioned text 11 for a first list 5 of key words, referred to in the following as first key word list 5. In this context, first key word list 5 is stored in memory 15. In the process, key word lists for a plurality of texts may be stored in memory 15, such as a second key word list 25, as shown in FIG. 1, for which selection means 45 may select word groups from a second text. To compile a plurality of texts, a shared key word list 30 is provided in memory 15, for which selection means 45 likewise select word groups from the resultant total text. Connected to selection means 45 are summing means 60 which add the frequencies of occurrence of the same word groups in various key word lists of texts to be merged and likewise store them in shared key word list 30 in association with the particular corresponding word group. All key word lists 5, 25, 30 are stored in memory 15. Also stored in memory 15 is a text component list 20, which includes predefined text components used by partitioning means 35 for partitioning first text 10 specified in this example.

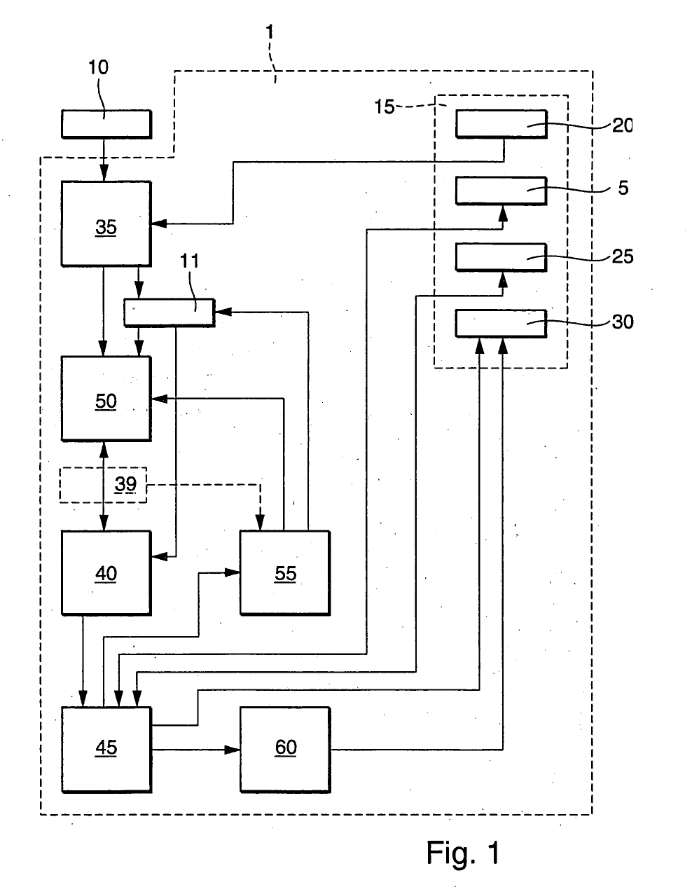

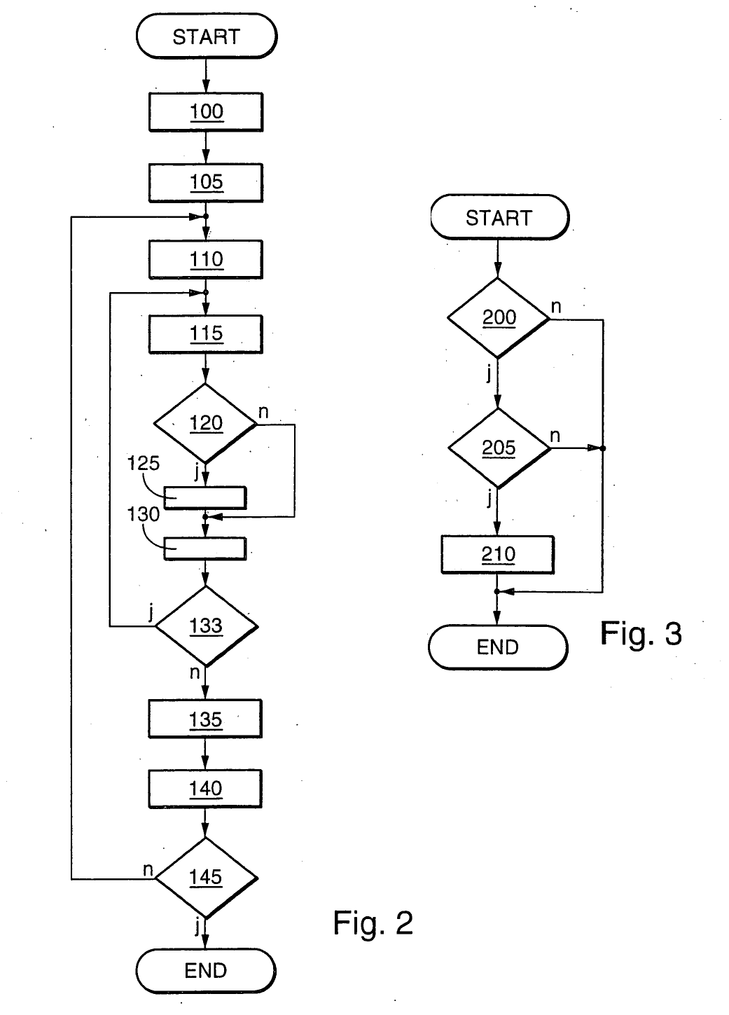

The method according to the present invention is first described for generating key word groups for first text 10 on the basis of the flow chart according to FIG. 2. At a program point 100, first text 10 is fed to partitioning means 35. Partitioning means 35 scan first text 10 for predefined text components stored in text component list 20. These text components include punctuation marks and words that are meaningless in terms of content, such as articles, linking words, such as “and” and “or” and the like. These predefined text components are detected in first text 10 by partitioning means 35 and replaced by delimiter marks, such as hash symbols. In this manner, one obtains partitioned text 11, in which text chunks are separated from one another by the mentioned delimiter marks. The program subsequently branches to a program point 105.

At program point 105, a first number n of directly adjacent words, for example n=5, is preset by search tool 50. The program subsequently branches to a program point 110.

At program point 110, the remaining text chunks in partitioned text 11 are scanned by search tool 50 for all word groups composed of precisely n directly adjacent words, i.e., words which are not separated from one another by delimiter marks. The ascertained word groups are buffer stored, for example likewise in memory 15, or, as assumed in this exemplary embodiment, in search tool 50 itself. The program subsequently branches to a program point 115.

At program point 115, means 40 for ascertaining the frequency of occurrence, determine the frequency of occurrence of one of the word groups buffer stored in search tool 50 and having n directly adjacent words in partitioned text 11. Means 39 for detecting a noun may additionally be provided before means 40 for determining frequency of occurrence, as indicated by dotted lines in FIG. 1. Prior to ascertaining the frequency of occurrence, means 39 for detecting a noun verify, in this context, at program point 115, whether, in each instance, the last word of the word groups buffer stored in search tool 50 is a noun. The word groups, which end with a noun, subsequently undergo the frequency-of-occurrence determination, as described. The remaining word groups are erased from the intermediate memory of search tool 50 and from partitioned text 11 by deletion device 55, for which purpose, means 39 for detecting a noun are linked, for this option, to deletion device 55, as likewise illustrated by a dotted line in FIG. 1.

A noun may be recognized as the last word of a word group in a German text when the scan shows that the word begins with an upper case letter. If this is the case, then, in all probability, it is a noun. When the word does not begin with an upper case letter, then it is certainly not a noun, leaving spelling errors out of consideration.

Alternatively, using a lexicographical method, one may check whether the word is listed in a dictionary as a noun-positive selection- or as an adjective, adverb, or verb-negative selection. To this end, in its memory 15, computer unit 1 may include a dictionary memory. Negative selection means: the word is a noun when it does not match the entries in a dictionary memory which include adjectives, adverbs, and verbs. For a positive selection, it holds that: when the word to be examined matches an entry of the dictionary memory characterized as a noun at the time the word to be examined is compared to the entries of the dictionary memory, then the word is recognized as being a noun.

This method is, in fact, somewhat more intricate, but is, however, the more precise and less faulty, the greater the number of nouns there are listed in the dictionary memory. It is not only suited for German-language texts, but particularly also for texts in those languages in which nouns do not differ in their form from the other words, thus, for example, not by upper case letters at the beginning of the word.

If indicated, the dictionary memory should also include, i.e., as a function of the language used, all possible declension forms of the nouns, in order to be able to recognize a word to be scanned independently of its declension form. Another possibility involves reducing the word to be scanned to its stem, for example by lemmatization, as known, for example, from the publication, _{“}Development of a Stemming Algorithm” by Lovins, B. J., Mechanical Translation and Computational Linguistics, 11, 22-31 (1968).

The entries of the dictionary memory should then likewise be available as words that have been reduced to their stem. In the case of nouns, this is the same for all possible declension forms. In this case, the word stem of the word to be scanned is compared to the word stems in the dictionary memory and recognized as a noun when it agrees with a word stem characterized as a noun in the dictionary memory.

For example, the word stem of the word “Krankenhäuser” (hospitals) is “Krankenhaus” (hospital) and, in this case, also corresponds to the basic form of this word. Typically, however, the number of letters of the word stem of a word is less than the number of letters of the basic form of the word. In the case of a negative selection, the explanations apply accordingly.

When a lexicographical method based on the word stem principle is applied, it is possible to economize on memory space in the dictionary memory, since the need is eliminated for storing all declension forms existing in the language being used. The program subsequently branches to a program point 120. At program point 120, selection means 45 check whether the ascertained frequency of occurrence of the particular word group is greater than a first predefined value. If this is the case, the program branches to program point 125, otherwise the program branches to a program point 130.

At program point 125, the appropriate word group is entered into first key word list 5 in memory 15 and thus forms a key word group that characterizes first text 10. The program subsequently branches to program point 130.

At program point 130, selection means 45 prompt deletion device 55 to delete the last scanned word group from the intermediate memory of search tool 50, for which purpose, search tool 50 is linked to deletion device 55, as shown in FIG. 1. The program subsequently branches to a program point 133.

At program point 133, means 40 for ascertaining the frequency of occurrence check whether a further word group is stored in the intermediate memory of search tool 50. If this is the case, then the program branches back to program point 115, and the program is run through again, from program point 115 on, using, in each instance, the new word group extracted from the intermediate memory of search tool 50. Otherwise, the program branches to a program point 135.

At program point 135, selection means 45 prompt deletion device 55 to delete all word groups entered in first key word list 5 from partitioned text 11. The program subsequently branches to a program point 140.

At program point 140, the first predefined number of directly adjacent words is decremented in search tool 50 by one, so that a second predefined number of directly adjacent words is derived which is smaller by one than the first predefined number of words. A decrementation by more than one could, of course, also follow, for example. In the following, however, one shall assume a decrementation of the first predefined number of directly adjacent words, by one. The program subsequently branches to a program point 145.

At program point 145, search tool 50 checks whether the second predefined number is smaller than or equal to zero. If this is the case, the program is exited, and the first key word list 5 is complete. Otherwise, the program branches back to program point 110, and the program is run through again from program point 110 on. However, this is done for word groups composed of exactly the second predefined number of directly adjacent words. In the process, the program is repeated from program point 110 on using a decremented number of directly adjacent words at program point 140, for the word groups to be found in partitioned text 11, until it is exited via the yes branch at program point 145, i.e., until condition n smaller or equal to zero is fulfilled.

It may be provided, together with the key word or with the key word group, to also store the corresponding ascertained frequency of occurrence in memory 15 or in first key word list 5, in association with the corresponding key word or the corresponding key word group. However, this represents merely one option.

The program execution may be coordinated by a control (not shown in FIG. 1) of computer unit 1, which is linked to memory 15, to partitioning means 35, to search tool 50, to means 40 for ascertaining frequency of occurrence, to deletion device 55, to selection means 45, and to summing means 60.

Summing means 60 are only optionally necessary.

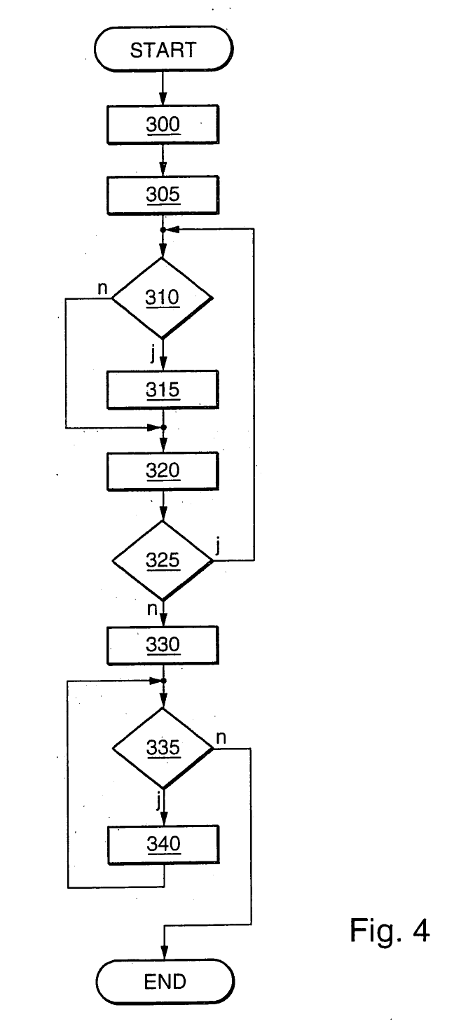

It may be provided for first text 10 to include a plurality of documents. For such a case, program points 120 and 125 in accordance with FIG. 2 are replaced with the sequence in accordance with FIG. 3. In this context, means 40 for ascertaining frequency of occurrence check at a program point 200 whether the frequency of occurrence of the word group just scanned exceeds a second predefined value in at least one predefined number of the documents in partitioned text 11. If this is the case, the program branches to a program point 205. Otherwise, the program is exited in accordance with FIG. 3 and branches further to program point 130 in accordance with FIG. 2. Program point 205 then corresponds to program point 120 in accordance with FIG. 2, i.e., means 40 for ascertaining frequency of occurrence check whether the word group just scanned in the total text occurs with a frequency that is greater than the first predefined value. If this is the case, the program branches to a program point 210. Otherwise, the program is exited in accordance with FIG. 3 and branches further to program point 130 in accordance with FIG. 2. Program point 210 in accordance with FIG. 3 corresponds then, in turn, to program point 125 in accordance with FIG. 2, where selection means 45 enter the word group just selected into first key word list 5. The program is subsequently exited in accordance with FIG. 3, and branches over further to program point 130 in accordance with FIG. 2. The predefined number of documents for the test procedure at program point 200 is selected to be smaller than or equal to the total number of documents in first text 10. The second predefined value for the test at program point 200 may be selected to equal zero, for example. This means that a word group that occurs with a frequency of occurrence in first text 10, thus the entire text, which is greater than the first predefined value, is only entered into first key word list 5 when it also occurs at least once in the predefined number of documents. In the process, the second predefined value may also be selected to be greater than zero. This, prevents a word group from being entered into first key word list 5 for the sole reason that the author of one of the documents has a preference for this word group, while it does not turn up in the remaining documents and is, therefore, also not representative or characteristic of the entire text, thus, of first text 10.

The following describes how first key word list 5 may be adapted when a second text is added to first text 10 after first key word list 5 was already completely formed. It is a question, therefore, of updating first key word list 5. For this case, a flow chart is shown in FIG. 4. Before executing the program for updating first key word list 5 in accordance with FIG. 4, it is necessary to generate a second key word list 25 for the second text. This second key word list may likewise be stored in memory 15, as shown in FIG. 1. In the process, second key word list 25 may be formed from the second text in the same manner as described for first text 10. First key word list 5 is updated by forming a shared key word list 30, which may likewise be stored in memory 15 in accordance with FIG. 1 and which includes key words or.key word groups that are characteristic or representative of first text 10 and of the second text. During this updating process, a list number m is first set to 1 at a program point 300 in accordance with FIG. 4. The program subsequently branches to a program point 305. At program point 305, from the key word list having list number m equals 1, selection means 45 extract a key word or a key word group from first key word list 5. The program subsequently branches to a program point 310. At program point 310, selection means 45 check whether the key word taken from first key word list 5 is also contained in the key word list having the list number incremented by 1, thus in second key word list 25. If this is the case, the program branches to program point 315, otherwise the program branches to program point 320.

At program point 315, selection means 45 prompt summing means 60 to add the frequencies of occurrence of the key word, i.e., of the key word group just scanned, from the two key word lists 5, 25. The precondition for this is the presence of summing means 60 and the storing of the frequency-of-occurrence values in association with the corresponding key word or key word group in the corresponding key word list or in memory 15. The program subsequently branches to program point 320.

At program point 320, the key word or key word group just. scanned is entered into shared key word list 30, along with its frequency of occurrence, the frequency of occurrence being either the cumulative frequency of occurrence ascertained at program point 315 or, in the case that program point 315 was skipped, the frequency of occurrence associated with the key word or key word group in first key word list 5. In addition, at program point 320, the key word just scanned is marked in first key word list 5 and, in the same manner, in second key word list 25, in the case that it is present there as well. This is prompted by selection means 45. The program subsequently branches to a program point 325.

At program point 325, selection means 45 check whether a key word or a key word group without any marking is present in first key word list 5. If this is the case, this key word or this key word group is selected, and the program branches back to program point 310. Otherwise, the program branches to a program point 330.

At program point 330, list number m is incremented by one. The program subsequently branches to a program point 335.

At program point 335, selection means 45 check whether a key word or a key word group without marking is present in the key word list having the list number incremented by one, thus, in this case, in second key word list 25. If this is the case, the program branches to program point 340, otherwise the program is exited. At program point 340, selection means 45 prompt the selection of such a key word or such a key word group without marking, from second key word list 25, and enter them into shared key word list 30 with the corresponding frequency of occurrence that is likewise stored in second key word list 25 or in memory 15. This key word or this key word group is subsequently marked in second key word list 25, and the program branches back to program point 335.

In this manner, by generating the shared key word list 30 in the manner described, first key word list 5 is able to be updated very quickly when adding a second text to first text 10, since there is no need to generate key words for the total text formed by first text 10 and the second text. Prior to updating first key word list 5, it is merely necessary to generate second key word list 25 for the second text.

The control (not shown in FIG. 1) may coordinate computer unit 1 for the sequence illustrated in FIGS. 3 and 4, as well. Also in the case of shared key word list 30, the frequency of occurrence associated with the corresponding key words or key word groups is also stored in memory 15 or in shared key word list 30, in association with the corresponding key word or key word group. In this context, in the method described in accordance with FIG. 4, the frequency of occurrence of a key word or of a key word group in shared key word list 30 always represents the sum of the frequencies of occurrence of this key word or of this key word group of first key word list 5 and of second key word list 25.

Word groups in partitioned text 11 may be deleted by deletion device 55 in that these word groups are likewise replaced by one or more delimiter marks. The text components predefined by the text component list may likewise by replaced by delimiter marks in that such text components are replaced with more than one symbol by one or more delimiter mark(s) for partitioning the text to be scanned, in order to generate the correspondingly partitioned text.

In the described method, longer word groups are entered into the corresponding key word list with a higher priority than the shorter ones.

It may be provided for the first predefined value and the first predefined number of directly adjacent words to be assigned to fixed memory in computer unit 1 or to be input by a user via an input unit (not shown in FIG. 1). The same holds for the decrementation increment for the predefined number of directly adjacent words. The predefined number of documents to be checked at program point 200 in accordance with FIG. 3, as well as the second predefined value may either be stored in fixed memory in computer unit 1 or entered by the user at the input unit.

When parameters to be preset may be input at an input unit of computer unit 1 for the sequence of the method according to the present invention in accordance with FIGS. 2, 3, and 4, then various values for these parameters may also be predefined for various texts, for each of which a key word list is to be generated. It may also be provided for a plurality of key word lists to be created for one single text. For these lists, various values are selected for the parameters to be preset, for example a variable entry for the first predefined value. When this is reduced following. generation of a first key word list for this text, then a second key word list including rarer key words or key word groups may be created for this text, by increasing the first predefined value. The texts to be scanned may be available, for example, as ASCII files or as HTML pages of the Internet.

It may be provided to reproduce key word lists 5, 25, 30 of memory 15 on an optical and/or acoustical reproduction device (not shown in FIG. 1). The generated key word lists may be used, for example, for searching for new texts which relate to the same special field as the already scanned first text 10 and for which, therefore, the same key words or key word groups are representative. For that reason, key word lists of this kind may be used, for example, when conducting patent searches. To conduct such a search, key words or key word groups may also be used directly from memory 15. For this purpose, computer unit 1 may be connected to the Internet, for example. This eliminates the need for the user to input the key words or key word groups. Provision may be made for the user to select the key words or key word groups offered to him on the reproduction device using a menu driven interface, for example a mouse pointer or cursor control, and to confirm the same using a confirmation key when searching for further texts for which the key words or key word groups from the stored key word list(s) 5, 25, 30 are characteristic.

The key word lists in memory 15 may be stored in memory 15 in association with an identification which characterizes the corresponding text. In this way, the key word groups may also be reproduced in association with the corresponding text. Thus, on the reproduction device, the user is able to discern which text the key word list just reproduced belongs to. By updating first key word list 5 using shared key word list 30 in accordance with the exemplary embodiment of FIG. 4, it is possible to recognize and follow trends in the characterization of texts which belong to one special field, for example, by ascertaining new accesses into shared key word list 30, or by determining key words or key word groups in shared key word list 30 whose frequency of occurrence increases in response to the addition of new texts in such a way that the increase exceeds a predefined value. When updating first key word list 5 by generating shared key word list 30, as described, it is ensured that key words or key word groups located once in first key word list 5 or second word list 25 are retained and are stored in shared key word list 30.

One further application provides for reproducing a text on a display device of the computer unit and for marking in color key words or key word groups of the corresponding key word list in this text, it being possible for the user to select previously single or all key words or key word groups from this key word list to be marked in color at the input unit of computer unit 1.

It may also be provided for the frequency-of-occurrence values ascertained by means 40 for determining the frequency of occurrence for the word groups ascertained by search tool 50 from partitioned text 11, to be stored in the form of a frequency-of-occurrence table in memory 15 or in means 40 for determining the frequency of occurrence or in search tool 50 itself and, in fact, in association with the corresponding word group.

It may also be alternatively provided that first text 10 is generated from a third text and a fourth text, a frequency-of-occurrence table having been stored for the third text and the fourth text, respectively, in the described manner for the word groups ascertained by search tool 50, in means 40 for ascertaining frequency of occurrence in search tool 50. In this context, the assumption should be, for example, that the frequency-of-occurrence table for the third text was created before the frequency-of-occurrence table for the fourth text, and that first key word list 5 was created for the third text. Shared key word list 30 shall, at this point, be ascertained for first text 10 encompassing the third text and the fourth text. This is achieved in that the two frequency-of-occurrence tables are cumulatively superposed to form one shared frequency-of-occurrence table which may likewise be stored in memory 15 or in means 40 for ascertaining the frequency of, occurrence. In the process, the frequencies of occurrence of word groups are added together when the word groups are listed both in the first frequency-of-occurrence table assigned to, the third text, as well as. in the second frequency-of-occurrence table assigned to the fourth text, and the cumulative frequency of occurrence is assigned in each instance in the shared frequency-of-occurrence table to the corresponding word group. The particular frequency of occurrence of the word groups, which are only stored in the first frequency-of-occurrence table or only in the second frequency-of-occurrence table, are entered, unchanged, in the shared frequency-of-occurrence table in association with the corresponding word group. Shared key word list 30 is then generated in the manner described in accordance with FIGS. 2 or 3, on the basis of the shared frequency-of-occurrence table for first text 10. The advantage over the specific embodiment described in accordance with FIG. 4 lies in that, when using the shared frequency-of-occurrence table, those word groups, which yield the frequency of occurrence necessary for inclusion in shared key word list 30, when the third text and fourth text are jointly considered, may also be entered into shared key word list 30, and whose frequency of occurrence in the third and in the fourth text, each considered individually, lies below the required frequency-of-occurrence threshold, thus the first predefined value, however.

What is claimed is:

1. A method for processing text in a computer unit (1), in which a first list (5) of key words is generated, a first text (10) being partitioned into a plurality of text chunks, which are separated from one another by predefined text components of a text component list (20) stored in a memory (15) assigned to the computer unit (1), and at least one component of a text chunk being entered into the first list (5) of key words, whose frequency of occurrence in the first text (10) exceeds a first predefined value, wherein, in a first step, all of those word groups are sought in the text chunks which include a first predefined number of directly adjacent words;
subsequently, of these word groups in the text chunks, those are deleted whose frequency of occurrence in the first text exceed the first predefined value and which are, therefore, entered into the first list (5) of key words; and, in a second step, all word groups in the remaining text chunks are sought which include a second predefined number of directly adjacent words, the second predefined number of words being smaller than the first predefined number of words.

2. The method as recited in one of the preceding claims, wherein the second predefined number of words is selected to be smaller by one than the first predefined number of words.

3. The method as recited in claim 1 or 2, wherein a plurality of documents is combined with the first text (10), and a word group is only entered into the first list (5) of key words when its frequency of occurrence exceeds a second predefined value in at least one predefined number of documents.

4. The method as recited in claim 1, 2 or 3, wherein the first text (10) is expanded by a second text having a second list of key words (25), and a shared list (30) of key words is generated into which a word group is entered when it is contained in the first list (5) of key words or in the second list (25) of key words.

5. The method as recited in claim 4, wherein the frequency of occurrence of a word group in the first list (5) of key words is added to the frequency of occurrence of the same word group in the second list (25) of key words, and the thus formed total frequency of occurrence of this word group is entered into the shared list (30) of key words in association with this word group.

6. The method as recited in claim 1, 2 or 3, wherein the first text (10) is formed from a third text, and a fourth text, the frequency of occurrence of an ascertained word group in the third text is added with the frequency of occurrence of the same word group in the fourth text, in order to ascertain the frequency of occurrence of this word group in the first text (10).

7. The method as recited in one of the preceding claims, wherein only those word groups which end with a noun are selected for inclusion in the first list (5) of key words.

8. A computer unit (1) for implementing the method as recited in one of the preceding claims, wherein means (35) are provided for partitioning a first text (10) into a plurality of text chunks;
the partitioning means (35) marks text components in the first text (10) which are stored in a memory (15) assigned to the computer unit (1);
the marked text components separate the text chunks of the first text (10) from one another;
means (40) are provided for ascertaining the frequency of occurrence of a word group contained in the text chunk;
selection means (45) are provided, which enter the word group into a first list (5) of key words stored in the memory (15) when the ascertained frequency of occurrence exceeds a first predefined value;
a search tool (50) is provided which searches all word groups, which include a first predefined number of directly adjacent words, in the text chunks;
a deletion device (55) is provided which deletes those of these word groups in the text chunks whose ascertained frequency of occurrence in the first text (10) exceeds the first predefined value and which, therefore, is entered into the first list (5) of key words;
the search tool (50) subsequently seeks all word groups in the remaining text chunks which include a second predefined number of directly adjacent words;
the second predefined number of words being smaller than the first predefined number of words.

9. The computer unit (1) as recited in claim 8, wherein the second predefined number of words is smaller by one than the first predefined number of words.

10. The computer unit (1) as recited in claim 8 or 9, wherein a plurality of documents is combined with the first text (10), and a word group is only entered by the selection means (45) into the first list (5) of key words when its ascertained frequency of occurrence exceeds a second predefined value in at least one predefined number of documents.

11. The computer unit (1) as recited in claim 8, 9, or 10, wherein the first text (10) is expanded by a second text having a second list (25) of key words stored in the memory (15);
a shared list (30) of key words is provided in the memory (15);
the selection means (45) enters a word group into the shared list (30) of key words when it is contained in the first list (5) of key words or in the second list (25) of key words.

12. The computer unit (1) as recited in claim 11, wherein summing means (60) are provided which add the frequency of occurrence of a word group in the first list (5) of key words to the frequency of occurrence of the same word group in the second list (25) of key words;
and the thus formed total frequency of occurrence of this word group is entered into the shared list (30) of key words in association with this word group in the memory (15).

13. The computer unit (1) as recited in claim 8, 9, or 10, wherein the first text (10) is formed from a third text and a fourth text;
the means (40) for determining the frequency of occurrence generate a first a frequency-of-occurrence table for all ascertained word groups of the third text and a frequency-of-occurrence table for all ascertained word groups of the fourth text, in which each word group is assigned the frequency at which it occurs in the corresponding text;
the means (40) for ascertaining the frequency of occurrence add the frequency of occurrence of a word group in the first frequency-of-occurrence table to the frequency of occurrence of the same word group in the second frequency-of-occurrence table, in order to ascertain the frequency of occurrence of this word group in the first text (10).

14. The computer unit (1) as recited in one of claims 8 through 13, wherein the selection means (45) enter a word group into the first list (5) of key words only when it ends with a noun.
